(19) United States
(12) Patent Application Publication
(10) Pub. No.: US 2019/0223648 A1
(43) Pub. Date: Jul. 25, 2019

(54) Beverage-Brewing Packaging Bag

(71) Applicant: Ze-Sheng Li, Quanzhou City (CN)

(72) Inventor: Ze-Sheng Li, Quanzhou City (CN)

(21) Appl. No.: 15/874,937

(22) Filed: Jan. 19, 2018

(51) Int. Cl. A47J 31/00; B65D 85/804; A47J 31/06; A47J 31/46

(52) U.S. Cl. CPC A47J 31/005; A47J 31/467; A47J 31/06; B65D 85/8043

(57) ABSTRACT

A beverage-brewing packaging bag includes an outer bag (10) and an inner bag (20). The outer bag (10) includes a receiving space (101). The inner bag (20) is received in the outer bag (10) and receives a to-be-brewed substance (30). The inner bag (20) is a filtering bag, is fixed to an inner face of the outer bag (10), and divides the receiving space (101) of the outer bag (10) into a water chamber (104) and a reservoir (105).

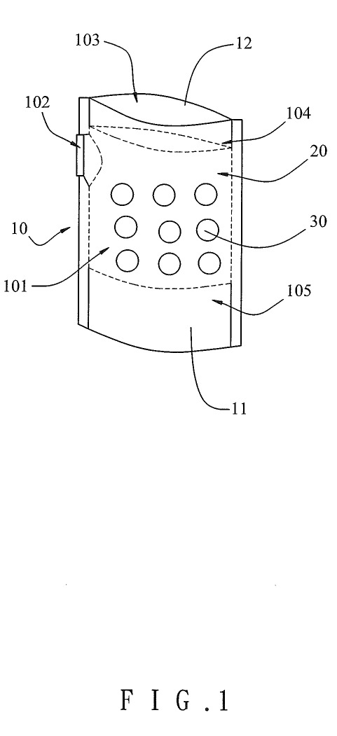

### BACKGROUND OF THE INVENTION

The present invention relates to the field of packaging technique and, more particularly, to a beverage-brewing packaging bag.

Nowadays, due to the rise of the consumption level and the quickening of the life pace of people, brewing-type beverages have become more and more popular among consumers. For example, instant coffee, tea leaves, soybean milk, etc. have been accepted and loved by many consumers due to the features of easy, fast brewing and easy carriage. However, most current brewing-type beverages are packed by packaging boxes and, thus, must be inconveniently taken out of the packaging boxes.

### BRIEF SUMMARY OF THE INVENTION

An objective of the present invention is to solve current problems by providing an easy-to-use beverage-brewing packaging bag.

To achieve the above objective, the present invention provides a beverage-brewing packaging bag including an outer bag and an inner bag. The outer bag includes a receiving space. The inner bag is received in the outer bag and is adapted to receive a to-be-brewed substance. The inner bag is a filtering bag, is fixed to an inner face of the outer bag, and divides the receiving space of the outer bag into a water chamber and a reservoir.

In an example, the inner bag includes an open end having a peripheral edge fixed to the inner face of the outer bag.

In an example, the outer bag further includes a plurality of pores. Each of the plurality of pores has a diameter smaller than a diameter of the to-be-brewed-substance to prevent the to-be-brewed-substance from falling out of the filtering bag.

In an example, the outer bag includes a water inlet directly communicating with the water chamber. The inner bag is configured to receive water filled through the water inlet of the outer bag and the water chamber, wherein the inner bag is adapted to filter a mixture of the to-be-brewed substance and water. The reservoir is adapted to receive the mixture filtered by the inner bag.

In an example, the outer bag further includes an outlet directly communicating with the reservoir, and wherein the outlet is disposed in a location adjacent to a top of the outer bag and higher than a lowest point of the inner bag.

In an example, the inner bag is made of nonwoven fabric.

In an example, the outer bag and the inner bag are fixedly connected by hot pressing.

In an example, the outer bag includes a front wall and a rear wall, wherein the front wall and the rear wall together define the receiving space, and wherein two edges of the front wall are fixedly connected to two edges of the rear wall by hot pressing.

In an example, the to-be-brewed substance includes tea leaves, coffee powder, soybean powder, or milk powder.

The present invention will become clearer in light of the following detailed description of illustrative embodiments of this invention described in connection with the drawings. It is noted that the illustrative embodiments are merely used to explain the present invention rather than to limit the present invention.

### DESCRIPTION OF THE DRAWINGS

The figure is a diagrammatic perspective view of a beverage-brewing packaging bag according to the present invention.

### DETAILED DESCRIPTION OF THE INVENTION

Unless indicated otherwise, the terms “first”, “second”, and “third” used herein are only used to identify different objects rather than to describe a specific sequence.

Unless indicated otherwise, when the directional terms “center”, “transverse”, “longitudinal”, “horizontal”, “vertical”, “top”, “bottom”, “inner”, “outer”, “upper”, “lower”, “front”, “rear”, “left”, “right”, “clockwise”, “counterclockwise”, and similar terms are used herein, it should be understood that these terms have reference only to the directional or positional relationship shown in the drawings and are utilized only to facilitate describing the illustrative embodiments rather than to indicate or hint that the indicated device or element must have a specific orientation or must be constructed or operated in a specific orientation, nor can it be interpreted to limit the protection scope of the present invention.

Unless indicated otherwise, the terms “fixed” or “fixedly connected” should be construed in a broad sense. Namely, two objects are connected without any positional movement relationship and relative rotational relationship therebetween, including non-detachable fixed connection, detachable fixed connection, integral connection, or any other fixed connection through a device or an element.

Unless indicated otherwise, the terms “comprise”, “include”, and similar terms used herein are used to express “include but not limited to”.

With reference to the figure, a beverage-brewing packaging bag according to the present invention includes an outer bag 10 and an inner bag 20 received and fixed in the outer bag 10.

The outer bag 10 includes a receiving space 101 therein. The outer bag 10 includes an outlet 102 and a water inlet 103. In this embodiment, the outer bag 10 includes a front wall 11 and a rear wall 12 which together define the receiving space 101. Two edges of the front wall 11 are fixedly connected to two edges of the rear wall 12 by hot pressing. To allow easy pouring of water, the water inlet 103 is disposed at a top of the outer bag 10.

The inner bag 20 is a filtering bag and receives a to-be-brewed substance 30. Furthermore, the filtering bag includes a plurality of pores. Each of the plurality of pores has a diameter smaller than a diameter of the to-be-brewed substance 30 to prevent the to-be-brewed substance 30 from falling out of the filtering bag. The inner bag 20 can be made of nonwoven fabric. The to-be-brewed substance 30 includes, but not limited to, tea leaves, coffee powder, soybean powder, milk powder, etc.

In this embodiment, the outer bag 10 and the inner bag 20 are fixedly connected by hot pressing. Specifically, the inner bag 20 is fixedly connected to the front wall 11 and the rear wall 12 of the outer bag 10 by hot pressing.

Regarding the inner bag 20 and the outer bag 10, the inner bag 20 is fixed to an inner face of the outer bag 10 and divides the receiving space 101 of the receiving space 101 of the outer bag 10 into a water chamber 104 and a reservoir 105. The inner bag 20 can include an open end having a peripheral edge fixed to the inner face of the outer bag 10, such that water entering the water chamber 104 can completely enter the open end of the inner bag 20 instead of directly entering the reservoir 105. It can be appreciated that the separation line between the water chamber 104 and the reservoir 105 is the hot pressing line between the open end of the inner bag 20 and the outer bag 10.

The water inlet 103 of the outer bag 10 directly communicates with the water chamber 104. The outlet 102 directly communicates with the reservoir 105. Furthermore, to assure that the reservoir 105 stores sufficient water, the outlet 102 is disposed at a position adjacent to the top of the outer bag 10.

When using the beverage-brewing packaging bag to proceed with brewing of a beverage, water is filled through the water inlet 103 of the outer bag 10 and directly passes through the water chamber 104 into an interior of the inner bag 20 to mix with the to-be-brewed substance 30. After mixing, the beverage (the mixture of the to-be-brewed substance 30 and water) is filtered by the inner bag 20 and enters the reservoir 105. When a user intends to drink, the filtered beverage in the reservoir 105 can be poured out via the outlet 102.

In can be appreciated that the inner bag 20 in the form of a filtering bag provides consumers with an easy-to-carry and easy-to-use brewing type beverage. Namely, when a consumer intends to drink, the consumer directly opens the packaging bag and fills boiled water to obtain the brewed beverage, which is not only convenient to the consumer but increases the life quality of the consumer.

In view of the foregoing, the beverage-brewing packaging bag according to the present invention includes the following advantages in comparison with the prior art:

1. The inner bag 20 in the beverage-brewing packaging bag is a filtering bag, is fixed to the inner face of the outer bag 10, and divides the receiving space 101 of the outer bag 10 into the water chamber 104 and the reservoir 105. Through use of the inner bag 20 in the form of the filtering bag receiving the to-be-brewed substance 30, easy brewing of a beverage can be easily attained to increase the experience of the user.

2. The peripheral edge of the open end of the inner bag 20 is fixed to the inner face of the outer bag 10, such that the inner bag 20 can be used to separate the water chamber 104 from the reservoir 105, avoiding water from directly entering the reservoir 105 without filtration by the inner bag 20 to thereby assure the brewing effect of the beverage.

3. The diameter of each of the plurality of pores of the filtering bag is smaller than the to-be-brewed substance 30 to be brewed. Thus, the to-be-brewed substance 30 is prevented from falling out of the filtering bag, assuring the brewing effect.

4. The outer bag 10 includes the outlet 102 directly communicating with the reservoir 105. The outlet 102 is disposed in a location adjacent to the top of the outer bag 10 and higher than the lowest point of the inner bag 20. The location of the outlet 102 permits the reservoir 105 to store a sufficient amount of liquid and, thus, assures the beverage storage capacity. Furthermore, the position of the outlet 102 higher than the lowest point of the inner bag 20 further assures the brewing effect.

5. The to-be-brewed substance 30 can be tea leaves, coffee powder, soybean powder, or milk powder to provide wider applications of the beverage-brewing packaging bag. Thus, easy, rapid, and better experience of beverage products can be provided for users having different tastes.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A beverage-brewing packaging bag comprising:
an outer bag including a receiving space; and
an inner bag received in the outer bag and adapted to receive a to-be-brewed substance,
wherein the inner bag is a filtering bag, is fixed to an inner face of the outer bag, and divides the receiving space of the outer bag into a water chamber and a reservoir.

2. The beverage-brewing packaging bag as claimed in claim 1, wherein the inner bag includes an open end having a peripheral edge fixed to the inner face of the outer bag.

3. The beverage-brewing packaging bag as claimed in claim 1, wherein the outer bag further includes a plurality of pores, wherein each of the plurality of pores has a diameter smaller than a diameter of the to-be-brewed-substance to prevent the to-be-brewed-substance from falling out of the filtering bag.

4. The beverage-brewing packaging bag as claimed in claim 1, wherein the outer bag includes a water inlet directly communicating with the water chamber, wherein the inner bag is configured to receive water filled through the water inlet of the outer bag and the water chamber, wherein the inner bag is adapted to filter a mixture of the to-be-brewed substance and water, and wherein the reservoir is adapted to receive the mixture filtered by the inner bag.

5. The beverage-brewing packaging bag as claimed in claim 4, wherein the outer bag further includes an outlet directly communicating with the reservoir, and wherein the outlet is disposed in a location adjacent to a top of the outer bag and higher than a lowest point of the inner bag.

6. The beverage-brewing packaging bag as claimed in claim 1, wherein the inner bag is made of nonwoven fabric.

7. The beverage-brewing packaging bag as claimed in claim 6, wherein the outer bag and the inner bag are fixedly connected by hot pressing.

8. The beverage-brewing packaging bag as claimed in claim 1, wherein the outer bag includes a front wall and a rear wall, wherein the front wall and the rear wall together define the receiving space, and wherein two edges of the front wall are fixedly connected to two edges of the rear wall by hot pressing.

9. The beverage-brewing packaging bag as claimed in claim 1, wherein the to-be-brewed substance includes tea leaves, coffee powder, soybean powder, or milk powder.
